(19) United States
(12) Patent Application Publication
(10) Pub. No.: US 2014/0047359 A1
(43) Pub. Date: Feb. 13, 2014

(54) MECHANISM FOR ADDING NEW SEARCH MODES TO USER AGENT

(71) Applicants: Arnstein Osnes TEIGENE, Oslo (NO); Richard TIBBETT, Oslo (NO); Knut-Jørgen V.RISHAUG, Oslo (NO)

(72) Inventors: Arnstein Osnes TEIGENE, Oslo (NO); Richard TIBBETT, Oslo (NO); Knut-Jørgen V.RISHAUG, Oslo (NO)

(21) Appl. No.: 13/569,311

(22) Filed: Aug. 8, 2012

(51) Int. Cl. G06F 3/01

(52) U.S. Cl. 715/760

(57) ABSTRACT

An application programming interface (API) is provided in a user agent to allow an extension to supplement the user agent's search bar functionality with the extension's own search suggestion(s) and/or functionality. Accordingly, as the user types characters into the search bar, the extension can generate an item for display in a drop-down search menu based on keyword or regular expression (regex) matching. Such item may be a search suggestion which, upon activation, redirect the user agent to a network resource. The item may also simply display the result of a function or calculation carried out by the extension. Furthermore, the user may choose to enter a search mode, giving the extension exclusive control over the contents of the search menu.

### FIELD OF THE INVENTION

The invention relates generally to extending the functionality of a user agent to add a new search mode to a user agent (e.g., web browser), and more particularly, to adding a new search mode in which an extension generates a suggested search result to be displayed while the user is typing in an address field or search field of the user agent.

### BACKGROUND OF THE INVENTION

Computer users typically use user agent applications such as web browsers to access various resources that are available over a computer network (e.g., Internet). Such resources include general information about a subject, image files, multimedia files, other types of applications (e.g., games or widgets), and so forth. Web browsers thus provide the user a way to identify the particular resource he/she wants to access. For instance, if the user knows the universal resource locator (URL) where the particular resource is located, he/she may enter it in an address field of the user agent. On the other hand, if the user does not know the particular URL, he/she may use the user agent to search the network for the resource, i.e., by entering one or more search terms. Many web browsers allow the user to enter such search terms into the address field. Also, many browsers provide a separate search field to enter the search terms.

In existing user agents, while the user is typing a search within the appropriate input field (address or search field), suggested search phrases may appear in a drop-down list extending below the input field. These search suggestions are formatted as simple text. The user may then select one of these search suggestions to be entered for the search using the ‘Tab’ or arrow keys, or using the mouse to click on the desired suggestion.

Furthermore, an application programming interface (API) is generally built into a user agent for the purpose of extending the user agent's functionality. The API defines ways in which other software applications may request services from the user agent. This allows “add-on” software to be written to extend the functionality of the user agent, based on vocabulary and calling conventions defined within the relevant API. A particular type of “add-on” that is used to extend the capabilities or data of the user agent is referred to as an “extension.” Furthermore, the API information can be published to allow third parties to develop extensions for the user agent.

Many types of these extensions can extend the search capabilities of the user agent. Existing desktop browsers attempt to utilize extensions to enhance the search. For instance, while the user is typing in a search into the address/search field, browsers like Google Chrome™ and Firefox® allow for activated extensions to generate suggested searches to be displayed in the drop-down list together with the suggested searches generated by the browser's native code. However, in these solutions, the user must enter a particular keyword in the address/search field, and the browser must perform keyword matching to trigger the extension into action. Further, the suggested searches generated are formatted as simple text, and cannot be more richly formatted. Also, based on this existing technology, there is no capability to enter a search mode in which the suggested searches in the drop-down list are exclusively generated by the extension.

### SUMMARY OF THE INVENTION

A system and method is described herein which allows for the functionality of a user agent to be extended, in regards to searching resources on a network (e.g., Internet), in an improved manner.

The present invention is directed to a system and method for executing a user agent (e.g., web browser) and an extension by a processor-based device (e.g., smartphone or tablet), the extension communicating with the user agent via an application programming interface (API) provided in the user agent; receiving, as input, characters typed by a user into a search bar of the user agent via a keyboard; performing, by the extension, keyword or regular expression matching on the inputted characters via the API; and generating, by the extension, an item to be displayed in a drop-down search menu below the search bar based on the keyword or regular expression matching. The item may be communicated from the extension to the user agent via the API.

According to exemplary embodiment of the present invention, the item may be generated by the extension in such manner that, when activated by the user, the item redirects the user agent to a corresponding resource on the network. For instance, the item may be associated with a Universal Resource Identifier (URI) or Universal Resource Locator (URL) corresponding to the resource.

According to another exemplary embodiment of the present invention, the extension may be triggered to produce a search menu item when the user types in a trigger word or phrase into the search bar. In this case, regular expression matching may be employed to detect the trigger word/phrase. Further, the item generated by the extension may be displayed in the search menu among other items generated by the user agent and/or other extensions.

According to another exemplary embodiment of the present invention, the extension may also have another capability in addition to searching. In such a case, the user may be able to designate a desired functionality and parameter in the search bar. The extension may be programmed to detect the desired functionality and parameter (e.g., through regular expression matching), apply the functionality on the parameter, and display the result as an item of the search menu.

According to another exemplary embodiment of the present invention, the user may be able to command the user agent to employ a search mode in which the extension controls the contents of the search menu. For instance, in the search mode, the extension may be responsible for generating all items displayed in the search menu.

Exemplary embodiments of the present invention may be implemented in a mobile device, such as a smartphone or a tablet device. Furthermore, the extension may be installed in such a mobile device (or another type of processor-based device) in such manner that, after installation, the device does not need to restart or reinstall the user agent.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein

FIG. 1 is a diagram illustrating an electronic device that can be used in connection with an exemplary embodiment of the present invention;

FIG. 2 is a diagram illustrating an example of a user agent that may be installed within an electronic device in accordance with an exemplary embodiment of the present invention;

FIGS. 3A-3C are flowcharts illustrating a process whereby an extension may enhance the capabilities of a user agent, particularly in regard to a search bar, according to an exemplary embodiment of the present invention;

FIGS. 4A and 4B illustrate an example scenario in which a simple utility extension generates and updates a search menu item based on the search bar input according to an exemplary embodiment of the present invention;

FIGS. 5A-5C illustrate an example scenario in which a search site extension is triggered and subsequently operated in an item search mode, according to an exemplary embodiment of the present invention; and

FIGS. 6A and 6B illustrate examples of rich formatting of search menu items by an extension, according to an exemplary embodiment of the present invention.

The drawings will be described in detail in the course of the detailed description of the invention.

### DETAILED DESCRIPTION

The following detailed description of the invention refers to the accompanying drawings.

The same reference numbers in different drawings identify the same or similar elements. Also, the following detailed description does not limit the invention. Instead, the scope of the invention is defined by the appended claims and equivalents thereof.

The present invention is directed to enhancing the functionality of an address field and/or search field (herein referred to as a “search bar”) in a user agent, e.g., web browser. According to the present invention, a user can add new functionality to the search bar by installing one or more extensions.

Principles of the present invention may be applied in the following context. As a user types (or otherwise inputs) textual input into the search bar of a user agent, a drop-down list of items matching that input (such list being herein referred to as a “search menu”) may be displayed below (or in proximity to) the search bar. Each of these items can be activated by the user (e.g., by clicking on it) to redirect the user agent to a particular URL (e.g., webpage) associated with the item. According to the present invention, an extension may respond to what the user is inputting into the search bar when appropriate. When triggered, an extension may generate item(s) to be displayed in the search menu along with the items generated by the user agent's native code and, possibly, other extensions. In the present invention, an extension may be triggered to produce its own search menu item in response to a trigger word or phrase being inputted into the search bar.

The item generated by the extension may be a search suggestion similar to those being produced by the native code of the user agent. Alternatively, the extension could generate the item so as to display the result of a simple functionality or calculation based on the search bar input. For instance, if the user types “2+2=” into the search bar, the extension could produce “4” as an item to be displayed in the search menu.

Further, while a search is conducted according to the present invention, the extension may (but is not required to) offer a search mode, during which the contents of the search menu are controlled exclusively by the extension.

Various principles of the present invention may be implemented by an application programming interface (API) that is provided in the user agent. Such an API may provide the following functionalities to an extension:
listen for one or more trigger words, like “where is” or “email”
listen for one or more defined regular expression (“regex”) matches of what is being typed into the search bar
serve a single search menu item, together with any native suggestions from the browser
enter search mode upon request from the user (by explicitly entering ‘Tab’ to enter search mode), wherein the extension will control all the entries in the search bar menu
display a rich, multi-line search menu item (e.g., including a picture, title and description)

The principles of the present invention may be implemented in a mobile environment in which users are able to browse the Internet using their mobile devices (phone, tablet computer, etc.), e.g., via a 3G or 4G-compliant network or a wireless network based on Wi-Fi (IEEE 802.11), WiMAX (WEE 802.16) or any other available standard for wireless communication. However, the present invention is not limited to a mobile implementation, and the principles described herein may also be applied to a desktop browsing environment.

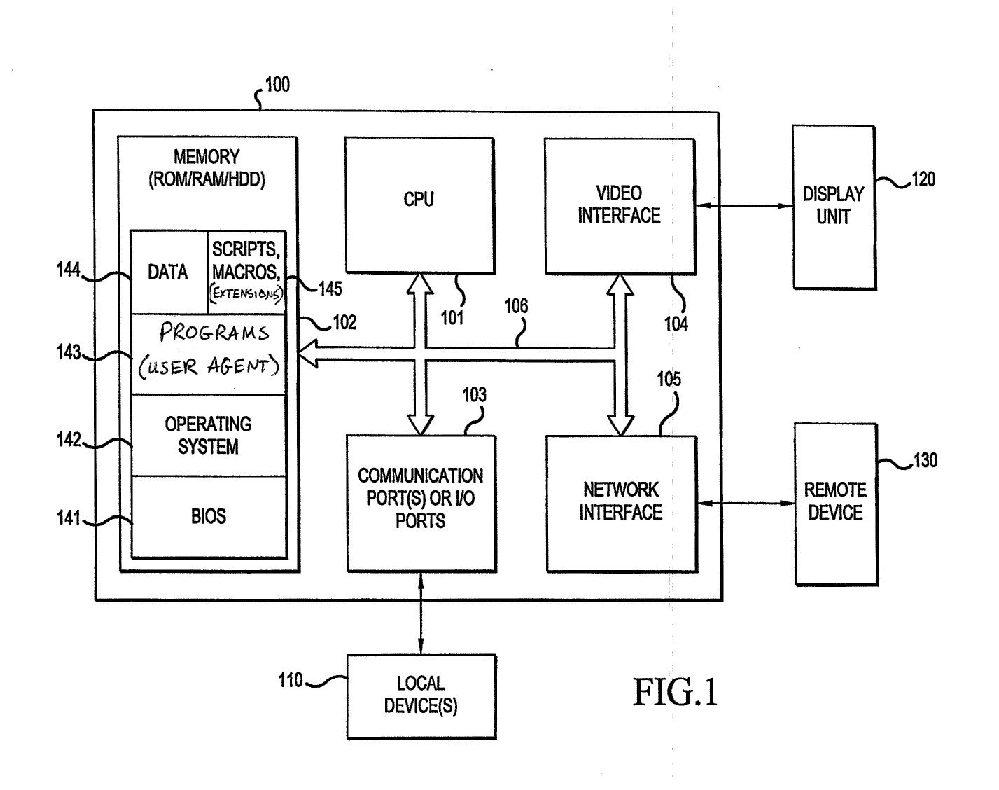

FIG. 1 illustrates a generalized computing device 100 that can be used as an environment for implementing various aspects of the present invention. For instance, the computing device 100 may be implemented as a client device, i.e., a user's computing device on which a web browser is installed to request webpages or resources from the server. Examples of such client devices include a mobile device (e.g., a smartphone, a tablet computer, etc.) or a general purpose desktop computer such as a PC. However, the computing device 100 of FIG. 1 may also be implemented as other types of specialized computing devices.

In FIG. 1, a computing device 100 has various functional components including a central processor unit (CPU) 101, memory 102, communication port(s) 103, a video interface 104, and a network interface 105. These components may be in communication with each other by way of a system bus 106.

The memory 102, which may include ROM, RAM, flash memory, hard drives, or any other combination of fixed and removable memories, stores the various software components of the system. The software components in the memory 102 may include a basic input/output system (BIOS) 141, an operating system 142, various computer programs 143 including applications and device drivers, various types of data 144, and other executable files or instructions 145 such as macros and scripts. For instance, the computer programs 143 stored within memory 102 may include a user agent (e.g., web browser) that may be executed in accordance with principles of the present invention. Further, the executable files/instructions 145 may include one or more extensions which used for enhancing the user agent's processing of search bar inputs, in accordance with the principles of the present invention.

In FIG. 1, the communication ports 103 may be connected to one or more local devices 110 such as user input devices, a printer, a media player, external memory devices, and special purpose devices such as, e.g., a global positioning system receiver (GPS). Communication ports 103, which may also be referred to as input/output ports (I/O), may be any combination of such ports as USB, PS/2, RS-232, infrared (IR), Bluetooth, printer ports, or any other standardized or dedicated communication interface for local devices 110.

The video interface device 104 is connected to a display unit 120 which may be an external monitor or an integrated display such as an LCD display. The display unit 120 may have a touch sensitive screen and in that case the display unit 120 doubles as a user input device. The user input device aspects of the display unit 120 may be considered as one of the local devices 110 communicating over a communication port 103.

The network interface device 105 provides the device 100 with the ability to connect to a network in order to communicate with a remote device 130. Such network, which in FIG. 1 is only illustrated as the line connecting the network interface 105 with the remote device 130, may be, e.g., a local area network or the Internet. The remote device 130 may in principle be any computing device (e.g., client or server) with similar communications capabilities as the device 100. Such remote device 130 (e.g., server) may be configured to distribute extensions to the computing device 100.

It will be understood that the device 100 illustrated in FIG. 1 is not limited to any particular configuration or embodiment regarding its size, resources, or physical implementation of components. For example, more than one of the functional components illustrated in FIG. 1 may be combined into a single integrated unit of the device 100. Also, a single functional component of FIG. 1 may be distributed over several physical units. Other units or capabilities may of course also be present.

In an exemplary embodiment, various aspects of the present invention may be incorporated into, or used in connection with, the components and/or functionality making up a web browser installed as an application on a device 100. While the terms “web browser” and “browser” are used throughout this specification, it should be understood that such terms are not intended to limit the present application only to traditional web browser programs, but instead cover any type of user agent or web application that is capable of sending URL requests for data resources (including, but not limited to, web pages) over the World Wide Web consistent with the principles of the present invention. Certain embodiments of the invention may also involve applications that access content that has already been made available locally without communicating with other networked devices.

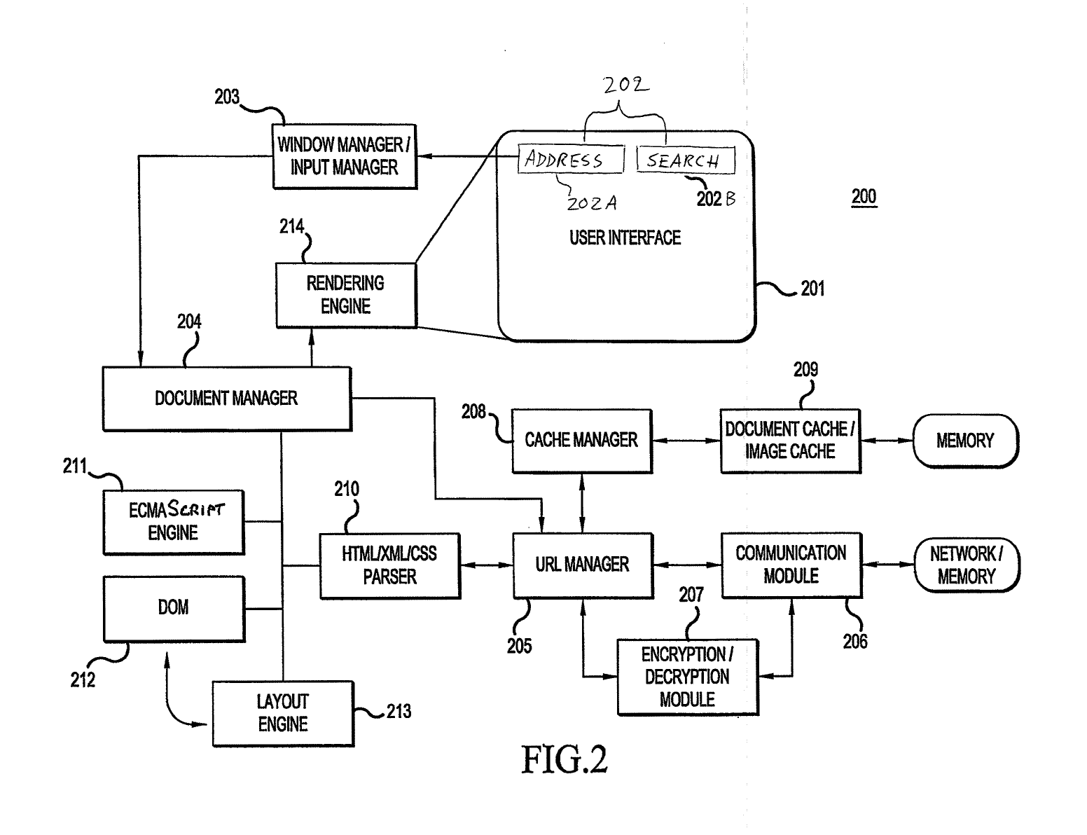

FIG. 2 illustrates the basic architecture of a web browser 200 that can be used in connection with the present invention. Particularly, FIG. 2 shows an example of various modules that may be present in such a web browser 200. The modules will typically be software modules, or otherwise implemented by a programmer in software, and may be executed by the CPU 101. However, it is also possible for any of the modules of FIG. 2 to be implemented as hardware, a combination of hardware and software, or “firmware,” as will be contemplated by those skilled in the art.

The web browser 200 presents the user with a user interface 201 that may be displayed on the display unit 120 shown in FIG. 1. The user interface 201 may include an address field 202A in which the user may input or select the URL of a document or a service he or she wants the browser 200 to retrieve. For example, the user may use a keyboard to type in the URL in the address field 202A. In addition, the browser 200 may include a separate search field 202B, e.g., located on another toolbar than the address field 202A, in which the user may type in one or more search terms to be sent to a dedicated search engine. For purposes of the present application, either and/or both the address field 202A and search field 202B of the web browser 200 may be configured to operate as a “search bar” 202 in accordance with the principles of the present invention. Furthermore, even though exemplary embodiments contemplate the use of a keyboard as an input device for typing in characters (e.g., search terms) into the search bar 202, other types of input devices may be used. For instance, a user may be able to use a voice recognition device to input characters or words into the search bar 202.

In any case, the URL may be received by a window and input manager 203, which handles inputs for the user interface 201 of the browser 200. The URL may then be forwarded to a document manager 204, which manages the data received as part of the document identified by the URL.

The document manager 204 forwards the URL to a URL manager 205, which instructs a communication module 206 to generate a web page request, i.e., a request for access to the identified resource. The communication module 206 may be capable of accessing and retrieving data from a remote device 130 such as a server over a network using the hypertext transfer protocol (HTTP), or some other protocol such as HTTP Secure (HTTPS) or file transfer protocol (FTP). The communication module 206 may also be capable of accessing data that is stored in the local memory 102 of the computing device 100.

Referring again to FIG. 2, the web browser 200 may include an encryption/decryption module 207 to handle communication between the URL manager 205 and the communication module 206, if communication outside the computing device 100 is required to be encrypted (e.g., as specified by the protocol used for accessing the URL).

The data received by the communication unit 206 in response to a webpage request is forwarded to the URL manager 205. The URL manager 205 may then store a copy of the received content in local memory 102 using a cache manager 208 which administers a document and image cache 209. If the same URL is requested at a later time, the URL manager 205 may request it from the cache manager 208, which will retrieve the cached copy from the cache 209 (unless the cached copy has been deleted) and forward the cached copy to the URL manager 205. Accordingly, it may not be necessary to retrieve the same data again from a remote device 130 when the same URL is requested a second time.

The URL, manager 205 forwards the data received from the communication port 206 or cache 209 to a parser 210 capable of parsing content such as HTML, XML and CSS. The parsed content may then, depending on the type and nature of the content, be processed further by an ECMAScript engine 211, a module for handling a document object model (DOM) structure 212, and/or a layout engine 213.

This processing of the retrieved content is administered by the document manager 204, which may also forward additional URL requests to the URL manager 205 as a result of the processing of the received content. These additional URL's may, e.g., specify images or other additional files that should be embedded in the document specified by the original URL.

When the data representing the content of the specified document has been processed it is forwarded from the document manager 204 in order to be rendered by a rendering engine 214 and displayed on the user interface 201.

The various modules thus described are executed by the CPU 101 of computing device 100 as the CPU 101 receives instructions and data over the system bus(es) 106. The communications module 206 communicates with the remote device 130 using the network interface 105. The functionality of various modules in FIG. 2 may of course be integrated into fewer larger modules. Also, the functionality of a single module in FIG. 2 may be distributed or replicated over several modules.

It will further be understood that, while the web browser 200 described above may be implemented as an application program 143 of the computing device 100, some of the browser's 200 functionality may also be implemented as part of the operating system 142 or even the BIOS 141 of the device 100. Further, the content received in response to a webpage request may include data 144, script 145, or a combination thereof.

As mentioned above, the search functionality of the web browser 200 may be extended or enhanced by an extension. For purposes of the present invention, an extension is a file containing programming that serves to extend or enhance the search bar 202 capabilities of the browser 200. For example, such an extension may be written as a “widget,” i.e., a particular type of web application package for distribution, in accordance with the specification “Widget Packaging and Configuration (Working Draft),” edited by Marcos Caceres, published by World Wide Web Consortium (W3C), Sep. 27, 2011 (hereafter referred to as “W3C-Widgets”), the entire contents of which are hereby incorporated by reference.

According to an exemplary embodiment, the web browser 200 may include an API that allows the extension to communicate with the browser 200 in regard to search bar 202 functionality. Hereinafter, such API may be referred to as a “search bar API.” Further, if the search bar API is published, third party developers may be able to author extensions for the particular browser 200. Particularly, knowledge of the API may allow third parties to write appropriate code to access the characters inputted to a search bar 202, and after processing such input, communicate one or more items to the browser 200 to be displayed in the search menu as a suggested match.

Examples of two different types of extensions that could be provided in accordance with the present invention are as follows:

### Example #1

### A Site Search Extension

In this example, an extension developer owns a website and wants to allow users to search the contents of that site from the search bar 202. The developer creates an extension and registers a DOMString-based keyword for the website. When the user types the registered keyword in the search bar 202, followed by a space and then some text, the extension creates an item for the search menu indicating to the user that the corresponding website can be searched simply by clicking on that item. When the user clicks on this item in the search menu, the extension will redirect the browser 200 to the search results page on the corresponding website, using the user's input from the search bar 202 as the search term on that page. Below, a particular example of a site search extension will be described in connection with one designed to search the Amazon™ website.

### Example #2

### A Utility Extension

In a second example, the extension developer wants to provide the user with simple functionality directly from the browser's search bar 202. Specific examples of this would include a calculator utility or a dictionary utility. First consider a simple calculator utility. In this case, regular expression (“regex”) matching may be employed to detect a mathematical equation inputted into the search bar 202. The extension may be notified when an equation is detected, and perform an appropriate calculation to be displayed in the search menu. E.g., if the user types “1+1,” the extension will be notified and will be able to display “2” in the browser search bar 202. The developer could also append a link to the displayed calculation result such that, when activated by the user (e.g., by clicking on it, or highlighting the item and pressing ‘Enter”), the browser is directed to a website containing a calculator app. Other types of utilities could also be implemented via extensions. For instance, an extension might provide a dictionary lookup function to the search bar 202. In this case, the user could type “define:” into the search bar 202, followed by a word to be looked up. When this syntax is detected, by regex matching for example, the extension may be triggered to produce a definition of the word to be displayed in the search menu.

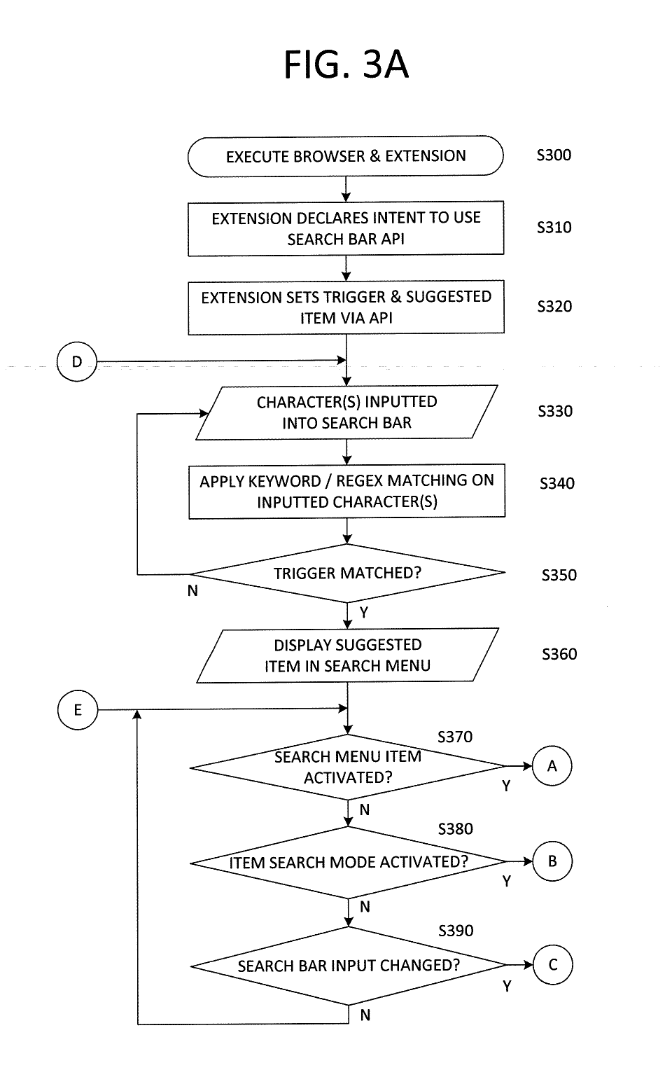

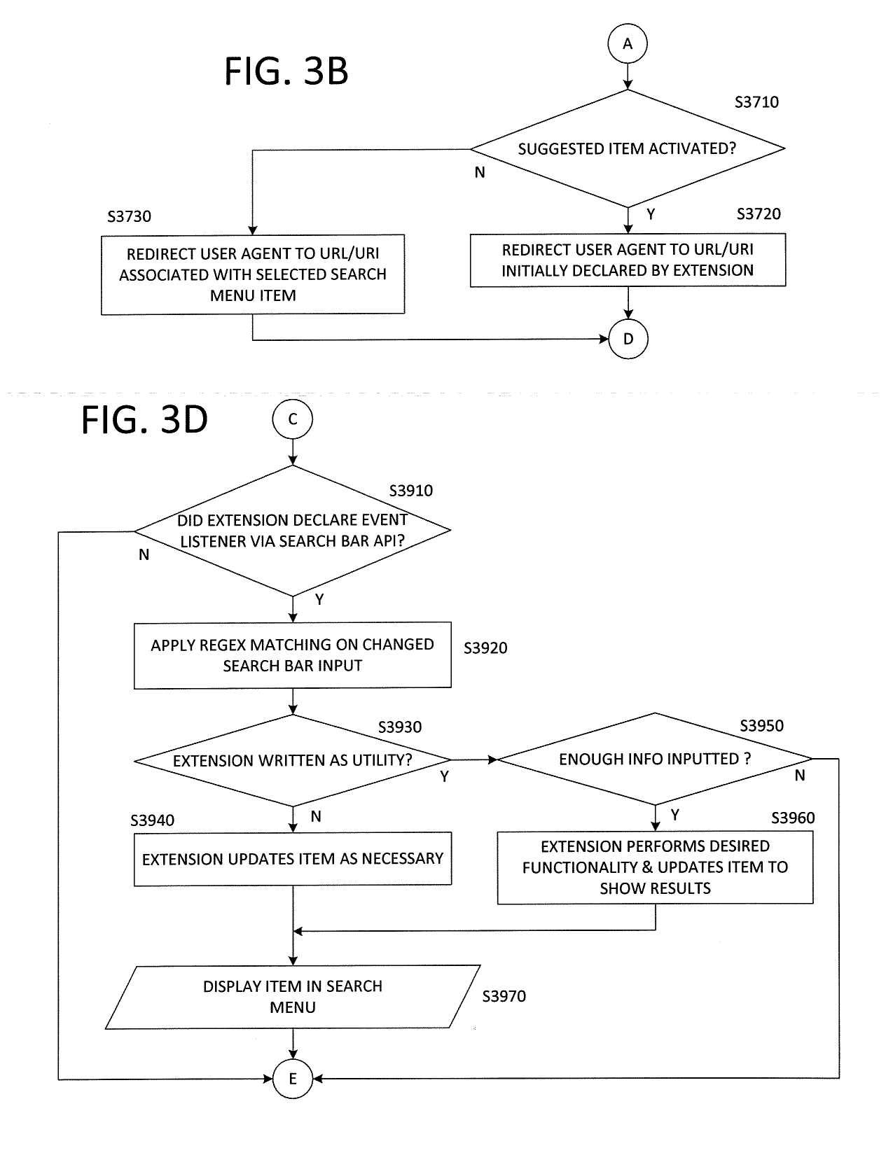

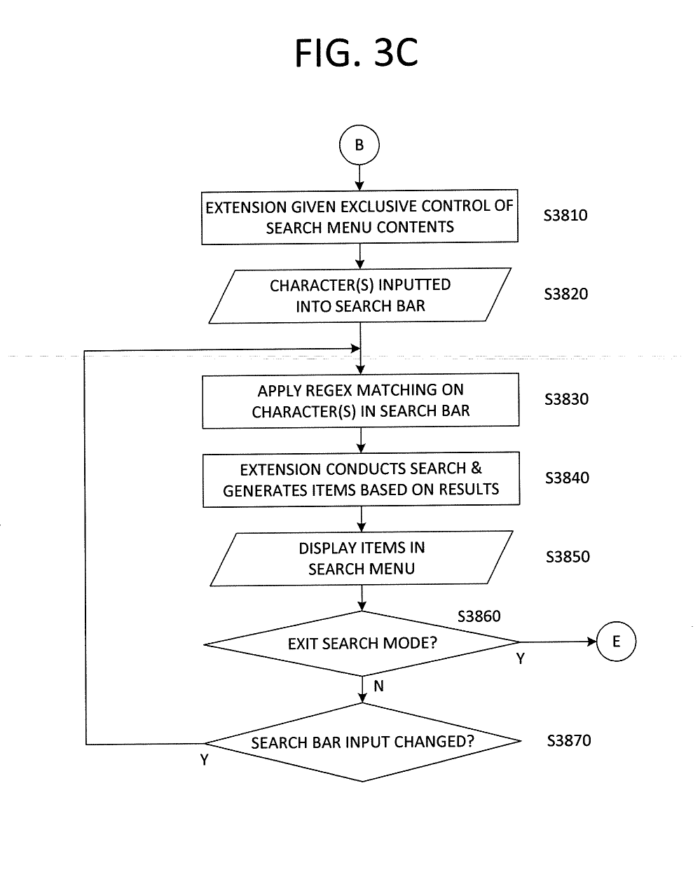

FIGS. 3A-3D are diagrams illustrating a process whereby an extension may enhance the capabilities of a web browser 200, particularly in regard to its search bar 202, according to an exemplary embodiment of the present invention.

It should be noted that FIGS. 3A-3D are intended to illustrate a particular example implementation of a process in accordance with the present invention, and are not intended to be limiting. For instance, the sequence of operations illustrated in these figures may be changed. Furthermore, certain operations may be omitted and/or other operations may be added, based on design/programming preferences or any other considerations.

It is contemplated that, when executed, the web browser 200 in combination with one or more extensions may control the CPU 101 of the device 100 to perform some or all of the operations illustrated in FIGS. 3A-3D. However, it is also possible that other programs may be executed in the device 100 to perform one or more of the operations, possibly in conjunction with the browser 200.

As shown in operation 5300 of FIG. 3A, the web browser 200 is executed. This in turn will cause any extensions installed in connection with the browser 200 to be executed. Such an extension may be installed in the device 100 apart from the web browser 200. In fact, the browser 200 may be used to navigate to a particular website, and download the extension. This may occur, e.g., if the extension is written by a third party developer, or provided as an update to the browser 200. In another embodiment, however, the extension may be installed when the browser 200 is installed. E.g., the extension could be packaged along with other installation files for the browser 200.

Referring again to FIG. 3A, in operation S310, the extension declares an intent to use the search bar API of the browser 200. If the extension conforms to the specifications set forth in W3C-Widgets, operation S310 could be accomplished by declaring a feature request in the configuration file of the extension. Formal definitions for the terms “feature request” and “configuration file” as used herein can be found in W3C-Widgets. Basically, the extension is making a request to add at least one item to the drop-down search menu when the user's input in search bar 202 matches a keyword or regex rule defined within the extension.

According to an exemplary embodiment, it is optional for the web browser 200 to grant the feature request to the extension.

As an example of operation S310, reference will now be made to the utility extension described above in Example #2, and particularly to a simple calculator utility. For this particular example (as well as others described below), the name attribute of the feature element will be opera:searchbar. Assuming that the configuration file for the extension is written as an extensible markup language (XML) file, the code by which the extension declares the feature request could be written as follows:

1 <widget xmlns=“http://www.w3.org/ns/widgets”
id=“http://example.com/myextension”>
2 <name short=“SimpleCalc”>
3 Simple calculator utility for the search bar
4 </name>
5
6 <feature name=“opera:searchbar” required=“false”>
7 </feature>
8 </widget>

For purposes of this example, it will be assumed that the API root opera.contexts.searchbar will be made available to the background process of the extension as a result of the above feature request.

According to an exemplary embodiment, it is not required for the browser 200 to grant every extension, which makes a feature request, access to the search bar API. For instance, the browser 200 may be programmed to only grant access to the API if the extension satisfies certain rules or conditions.

After declaring its intent to use the search bar API, assuming that the browser 200 responds by granting access to the API, the extension may then set up a trigger in its background process via the API. This is illustrated in operation S320 of FIG. 3A. Particularly, the extension can define a set of characters (a word, phrase, or expression) which, when inputted by the user into the search bar 202, triggers the extension to create an item for the search menu. The extension can utilize either keyword matching or regex matching to listen for the trigger word(s) or expression in the search bar. Furthermore, when setting up the trigger according to operation S320, the extension can also declare a suggested item to be displayed in the search menu when the extension is triggered.

For instance, in the abovementioned example involving the simple calculator utility, operation S320 could be implemented in JavaScript using the following code:

1 // Create a default search suggestion for calculator utility extension:
2 var searchSuggestion = opera.contexts.searchbar.createSuggestion ({
3 key: /\hat{ }((\-?\d(\.\d+)?)+\s?[*\-+/]\s?)+(\-?\d(\.\d+)?)+$/,
4 //simple calculator regular expression matcher e.g. “−23+4 *8.5”
5 title: “= . . .”,
6 href: “http://mycalculator.com”
7 });
8
9 // Attach the search suggestion to the browser:
10 opera.contexts.searchbar.setDefaultSuggestion (searchSuggestion);

According to this code, a regex matching rule (see line 3 in above code) is utilized to trigger the extension to display the suggested item “= . . . ” (see line 5 in above code) in the search menu, i.e., as the user starts typing a mathematical equation into search bar 202. This search menu item is associated with the following URL: http://mycalculatorcom. As such, if the user activates this search menu item (e.g., by clicking on it), the browser 200 will be redirected to the corresponding URL.

While particular examples are described herein in which search menu items are associated with URL's, this is not required. For instance, an extension may decide to associate the item with another type of URI, or may simply opt not to associate any URL or URI with the item.

As another example, consider the site search extension as described in Example #1 above. The code in the configuration file for setting the trigger and a suggested search menu item could be written in JavaScript as follows:

1 // Create and add a default search suggestion for Amazon search
extension:
2 var searchSuggestion = opera.contexts.searchbar.createSuggestion ({
3 key: “amazon”,
4 title: “Search amazon”,
5 onclick: function( e ) {
6 e.source.url = “http://amazon.com/s”
7 }
8 });
9 opera.contexts.searchbar.setDefaultSuggestion ( searchSuggestion );

In the above code, the extension specifies the use of keyword matching on the search bar input to detect “amazon” as a trigger (see line 8 in above code). Detection of this keyword triggers the extension to produce the suggested item “Search amazon” (see line 9 of above code), such item being associated with the URL http://amazon.com/s, i.e., the search page of the website (see lines 10-12 of above code).

Referring again to FIG. 3A, in operation S330, the user starts typing or otherwise inputting characters (letters, numerical digits, symbols, etc.) into the search bar 202. Thereafter, either keyword or regex matching, as specified by the extension, is applied in operation S340 to detect the extension's trigger. If the trigger is matched, as indicated by the “Y” decision in operation 5350, the suggested search menu item is displayed in the search menu according to operation 5360.

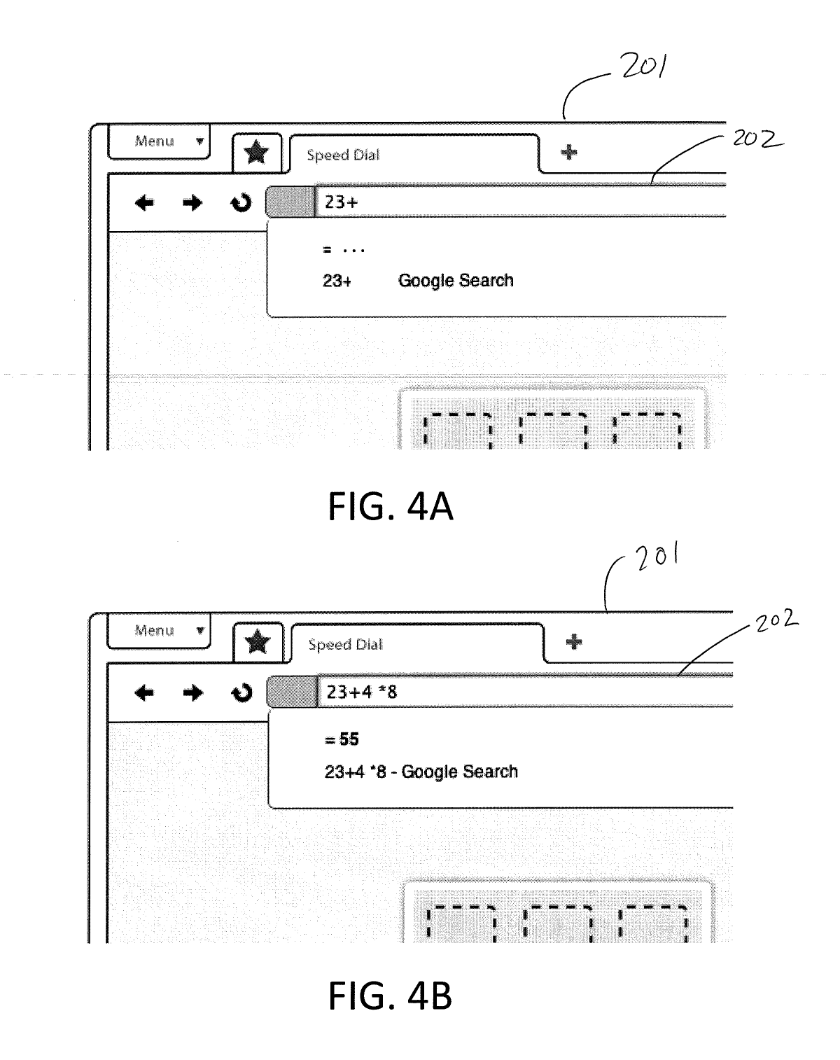

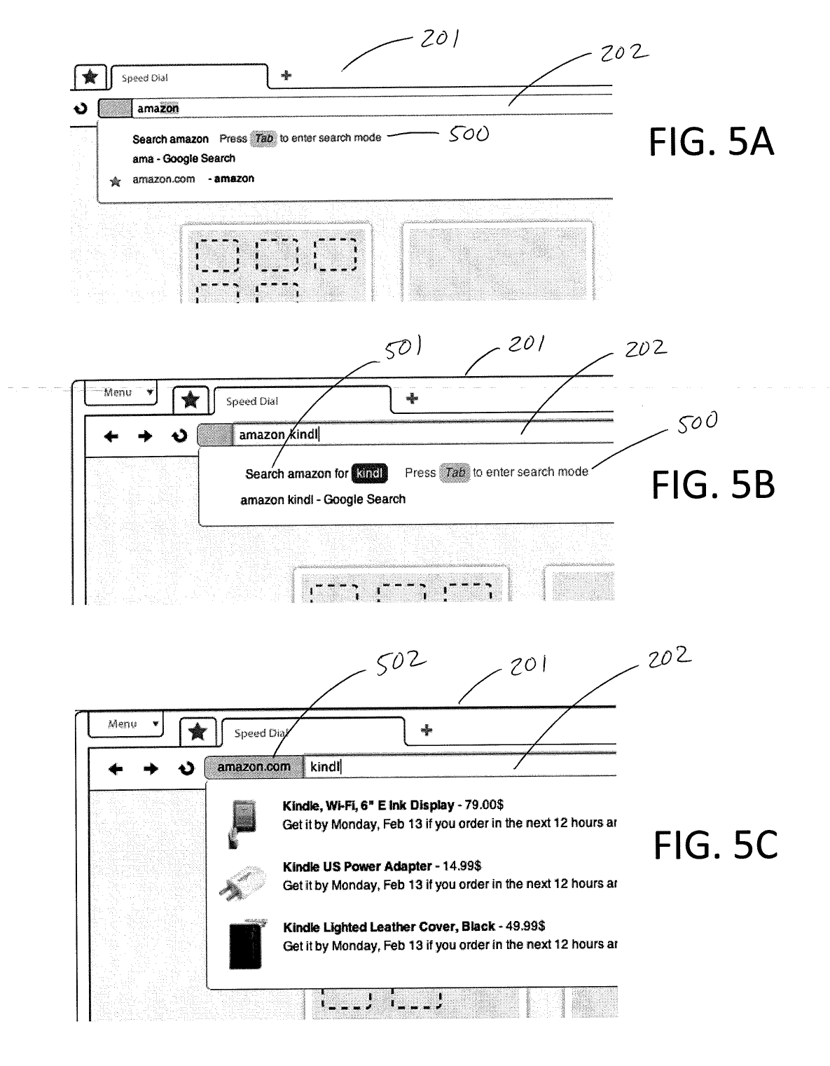

FIG. 4A illustrates the aforementioned example involving the calculator utility extension. As shown in this figure, the suggested item of “= . . . ” is displayed the search menu 202 as user starts typing an equation (“23+”) typed into search bar 202. FIG. 5A, on the other hand, illustrates the example involving the site search extension. As shown in FIG. 5A, when the keyword “amazon” is typed into the search bar 202, the extension is triggered to display the suggested item “Search amazon.”

Referring again to FIG. 3A, according to operation S370, the browser 200 checks whether the user has activated any item currently displayed in the search menu. In an exemplary embodiment, each item that is displayed in the search menu, which appears as a result of the user's input in the search bar 202, may be associated with a URL or URI. When the user activates any such item in the search menu (by clicking on it, highlighting it and pressing the ‘Enter’ key, etc.), this is detected as a “Y” decision in operation S370. Accordingly, processing proceeds as illustrated in FIG. 3B. As shown in FIG. 3B, the activated item could be the suggested search menu item that is created by the extension upon triggering, resulting in a “Y” decision in operation S3710. If, however, operation S3710 results in an “N” decision, this might mean that the activated item was one of the search menu items produced by the native code of the browser 200, or an item produced by the extension by updating the initial suggested item. At any rate, when the item is activated, the browser 200 may be redirected to the URL associated with the item as indicated in operations S3720 and S3730 of FIG. 3B. Thereafter, processing may return to FIG. 3A at point “D.”

However, instead of activating a search menu item to redirect the browser 200 to an associated URL or URI, the user may choose to activate a “search mode” associated with an item in the search menu that is generated by an extension. When such a search mode is activated by the user, the extension which generated the search menu item may be given the capability, by the search bar API, to generate more than one (and possible all of) the items displayed in the search menu. According to an exemplary embodiment, when the user activates the search mode for a particular item, the corresponding extension may even be granted exclusive control, by the API, of the contents to be displayed in the search menu.

For instance, upon being triggered by the search bar input, the extension may give the user the option to input a particular user command in order to enter a search mode. An example of this is shown in FIG. 5A, in which the suggested item of “Search amazon” initially generated by the extension gives the user the opportunity to enter the search mode by pressing the ‘Tab’ key. However, this is not intended to be limiting. For instance, other keys or inputs may be used to enter the search mode. Also, it is not necessary for the item to display instructions to how the user can activate the search mode, although it might be preferred (but not strictly necessary) for the search menu item to indicate that the extension supports the search mode functionality.

The search mode may be particularly applicable to extensions similar to the site search type example discussed above. Therefore, details of the search mode aspect of the present invention will be discussed in connection with this example.

If an extension intends to be eligible to operate in search mode, the extension may need to declare such intent to the browser 200 via the search bar API. For example, the extension may need to set an enableSearchMode attribute of the API to ‘true.’ In the abovementioned example of the search site extension, the following line of JavaScript code may be included:
opera.contexts.searchbar.enableSearchMode=true;

Furthermore, the extension will also need to be notified via the API of changes to the user's input in the search bar 202, i.e., the addition or removal of characters from the search bar 202. To accomplish this, the extension may need to declare an event listener via the search bar API, specifically for use in search mode. This could be accomplished, for instance, utilizing the following JavaScript code:

| | |
|---|---|
| 1 | // Handle a search mode input event (only fired if search mode is activated) |
| 2 | opera.contexts.searchbar.addEventListener ( ‘searchinput’, function( e, suggest ) { |
| 3 | |
| 4 | var amazonSearchAutoCompleteURL = “http://asp.assoc-amazon.com/suggestions ? |
| 5 | = {searchTerms}&t=searchsuggest − 10”; |
| 6 | |
| 7 | searchSuggestion .content = “amazon.com”; // set the item search mode tooltip |
| 8 | |
| 9 | if( e.regexMatches .length < 1 ) |
| 10 | return; |
| 11 | |
| 12 | var searchUrl = amazonSearchAutoCompleteUrl.replace ( “{searchTerms}”, |
| 13 | e.regexMatches [0] ); |
| 14 | |
| 15 | // Obtain and parse Amazon Search Results |
| 16 | // In this example, JXON parser library is used |
| 17 | var parser = new JXON.Parser( ); |
| 18 | parser.parseXMLFile ( searchUrl, function( jxon ) { |
| 19 | |
| 20 | if( !jxon \|\| !jxon.SearchSuggestion \|\| !jxon.SearchSuggestion .Section \|\| |
| 21 | jxon.SearchSuggestion .Section.Item.length < 1) |
| 22 | return; |
| 23 | |
| 24 | var suggestions = [ ]; |
| 25 | |
| 26 | var searchResults = jxon.SearchSuggestion.Section.Item; |
| 27 | |
| 28 | for(var i = 0, 1 = searchResults.length; i < 1; i++) { |
| 29 | |
| 30 | // Create a new search menu item |
| 31 | var suggestion = opera.contexts.searchbar.createSuggestion ({ |
| 32 | title: searchResults [i].Text[“#text”], |
| 33 | description : searchResults [i].Description [“#text”], |
| 34 | icon: searchResults [i].Image[“@source”], |
| 35 | href: searchResults [i].Url[“#text”] |
| 36 | }); |
| 37 | |
| 38 | // Store new search menu item in array |
| 39 | suggestions.push( suggestion ); |
| 40 | } |
| 41 | |
| 42 | // Add all new search menu items to the user agent suggest (in search mode) |
| 43 | opera.contexts.saerchbar.suggest( e.text, suggestions ); |
| 44 | |
| 45 | }); |
| 46 | |
| 47 | }, true); |

Referring again to FIG. 3A, a decision is made in operation S380 as to whether the user has entered an item search mode. If so (as indicated by the “Y” decision”), processing proceeds as illustrated in FIG. 3C. As shown in FIG. 3C, the browser's search bar API gives the extension exclusive control of the contents of the search menu in accordance with operation S3810. Thereafter, operations S3820 through S3870 are performed. These operations may be implemented using an event listener, which is declared by the extension and specifically designed for search mode. For instance, in the example involving the site search extension, the above event listener code might be executed.

According to operation S3820, the user enters another character (or possibly multiple characters) into the search bar 202. Regex matching may be applied to the search bar input according to operation S830. Then, the extension can conduct a search on the appropriate website based on the matched expression, and generates search menu items based on the results of the search, according to operation S840. In the above event listener code, for example, lines 12-13 can be used to conduct the search based on the regex matching, while lines 15-24 can be used to parse the results that are returned from the website, and lines 26-39 creates a set of items for the search menu based on the parsed results. According to operation S3850, the items are displayed in the search menu.

FIGS. 5A-5C illustrate a scenario in which an extension is triggered and subsequently operated according to item search mode. The illustrated scenario is particularly related to the above example regarding a search site extension, i.e., one for searching Amazon. In FIG. 5A, the extension is triggered and generates the initial suggested item “Search amazon.” However, as shown in FIG. 5A, since the extension is enabled for search mode, the item may be displayed along with an instruction 500 as to how to activate the item search mode (i.e., “Press Tab to enter search mode). In FIG. 5B, before deciding to enter search mode, the user may continue inputting characters into the search bar 202 thereby causing the extension to produce an updated search menu item 501. The instruction 500 for activating the search mode for the extension may still be displayed at this point. Then, the user may press the ‘Tab’ key to enter search mode as illustrated in FIG. 5C. In search mode, the extension may apply a regex matching rule to extract the set of characters (“kindl”) following the trigger word (“amazon”) in the search bar 202, and conduct the website search based on the extracted characters. Accordingly, as shown in FIG. 5C, the extension parses the search results, and displays a corresponding set of search menu items. Also, the search bar 202 may be modified to indicate to the user that it is now operating in an item search mode, e.g., by displaying the tooltip 502 (“amazon.com”). As such, in FIG. 5C, a tooltip 502 comprising “amazon.com” is displayed in the search bar 202 to notify the user that search mode has been entered.

Furthermore, as shown in FIG. 5C, the search menu items are not limited to plaintext. Instead, the extension may create rich, multi-line search menu items each of which may include images and syntax highlighting. For instance, in the example of FIG. 5C, the website search may come up with an image for each search result, and this image may be included in the corresponding search menu item along with a title and description. Furthermore, the search bar API may include syntax highlighter markup that allows an extension to style the text fields of its search menu items. E.g., the API may provide an XML (extensible markup language)-style markup, which supports the following tags: ‘url’ for a literal URL; ‘match’ for highlighting the words matching the user's search terms; and ‘dim’ for dimming certain text (e.g., to dim certain helper text like instruction 501).

According to an exemplary embodiment, an extension may only be allowed to use the above enhancements (image, syntax highlighting, and/or multiple lines) for its search menu items when the item search mode is activated. However, in an alternative embodiment, an extension may also be allowed to create a search menu item with such enhancements while the search bar 202 is operating in standard mode.

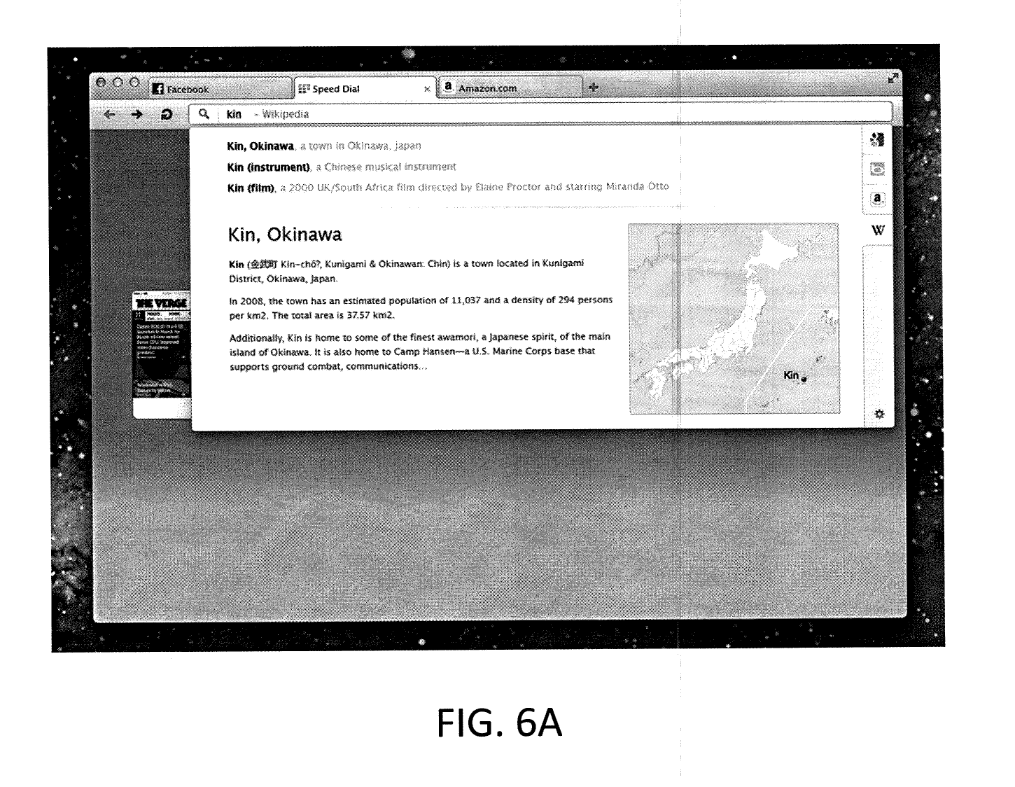

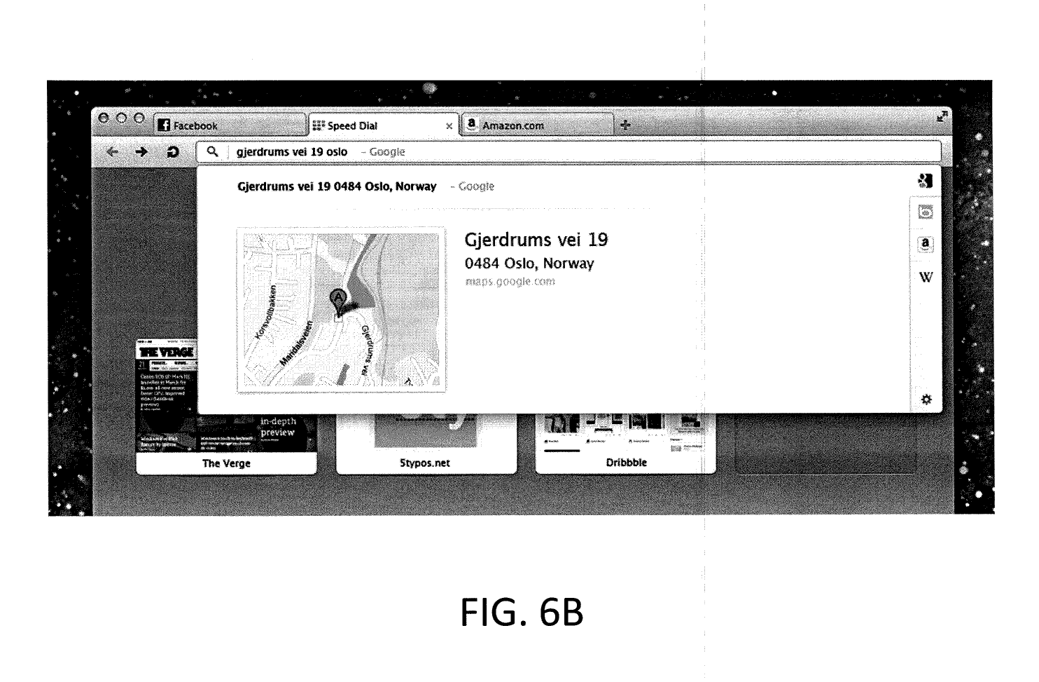

Further examples of the rich formatting of search menu items which can be produced by an extension are illustrated in FIGS. 6A and 6B. As shown in FIG. 6A, a utility extension could produce a search menu item including a textual description and map of a particular city/geographical region. Another type of utility extension could, as shown in FIG. 6B, produce a map of a specific street address as the search menu item using the rich formatting feature of the present invention.

Referring again to FIG. 3C, the user may be given the option to exit the item search mode as shown in operation S3860. For instance, the user may be able to exit search mode by pressing the ‘ESC’ key or by another designated key or input. If the user decides to exit search mode for the extension (“Y” decision in operation S3860), the search bar 202 may return to the standard mode of operation, e.g., by returning to point “E” of FIG. 3A. However, while the extension continues to operate in search mode (“N” decision in operation S3860), the extension will continue to listen for changes in the search bar input, e.g., using the event listener.

Now, reference will be made back to FIG. 3A, again to operation S380. It will now be assumed that, instead of activating an item search mode (“N” decision in operation S380), the user instead inputted an additional character into, or deleted an inputted character from, the search bar 202 (“Y” in operation S390). Accordingly, processing proceeds as illustrated in FIG. 3D.

As shown in FIG. 3D, operation S3910 determines whether the extension has declared an event listener via the search bar API of the browser 200. Although an earlier section of this specification described the use of an event listener in connection with an item search mode, the search bar API could also allow an extension to declare an event listener for use apart from search mode. This would allow the API to notify the extension of changes to the search bar input while the search bar 202 is operating in standard mode.

For instance, a utility extension could declare an event listener via the search bar API. Consider again the example involving the simple calculator utility. The event listener could be declared using the following JavaScript code:

| 1 | // Handle a user input changed event | |
|---|---|---|
| 2 | opera.contexts.searchbar.addEventListener (‘input’, function( e ) { | |
| 3 | // Display the result directly in the search bar | |
| 4 | var result = calculate( e.regexMatches ); // ‘calculate’ function out of scope | |
| 5 | searchSuggestion.title = “= <match>” + result + “</match>”; | // update search menu |
| 6 | | // item w/result |

| | |
|---|---|
| 7 | searchSuggestion.href = “http://mycalculator .com?regex=” + |
| 8 | encodeURIComponent (e.text ); // update activation target |
| 9 | }, true); |

On the other hand, a site search extension could also declare an event listener for use when the search bar 202 is operating in the standard mode. In the example involving the extension for searching Amazon, the event listener could be declared with the following JavaScript code:

| | |
|---|---|
| 1 | // Handle a simple input event |
| 2 | opera.contexts.searchbar.addEventListener ( ‘input’, function( e ) { |
| 3 | |
| 4 | var amazonSearchBaseUrl = “http://www.amazon.com/s?field- |
| 5 | keywords={searchTerms}”; |
| 6 | |
| 7 | if( e.regexMatches .length > 0 ) { // user is searching for something other than “ ”: |
| 8 | |
| 9 | searchSuggestion .title = “Search amazon for <match>” + e.regexMatches [0] |
| 10 | + “</match>”; |
| 11 | |
| 12 | var searchUrl = amazonSearchBaseUrl.replace( “{searchTerms }”, e.regexMatches |
| 13 | [0] ); |
| 14 | |
| 15 | searchSuggestion .content = searchUrl; |
| 16 | searchSuggestion .onclick = function( e1 ) { |
| 17 | e1.source.url = searchUrl; |
| 18 | }; |
| 19 | |
| 20 | } else { |
| 21 | // Reset defaults |
| 22 | |
| 23 | searchSuggestion .title = “Search amazon”; |
| 24 | searchSuggestion .content = “http://amazon.com/s”; |
| 25 | searchSuggestion .onclick = function( e1 ) { |
| 26 | e1.source.url = “http://amazon.com/s”; |
| 27 | }; |
| 28 | } |

As shown in FIG. 3D, if operation S3910 determines that an event listener has not been declared by the extension (“N” decision), this means that no change will be made to the corresponding search menu (and processing can return to point “E” of FIG. 3A). However, if an event listener has been declared (“Y” decision in operation S3910), then regex matching can be applied to the search bar input according to operation S3920.

Next, if the extension is a utility extension (“Y” decision in operation S3930), the extension may be able to perform a functionality based on the input in the search bar 202. Thus, a determination may be made in operation S3950 as to whether enough information has been detected from the search bar input to enable the extension to perform a function, and update its search menu item with the results thereof. For instance, a utility extension may require the search bar input to indicate a desired functionality. A utility extension may also need the search bar input to designate one or more parameters on which the desired functionality is to be performed, although this might not always be the case. An example of a utility extension, which requires both functionality and parameter(s) to be detected from the search bar input, would be the simple calculator utility described above. For instance, if the search bar 202 contains the symbol “+,” this might indicate that the desired functionality is an addition operation. However, the calculator utility would still be unable to perform this operation until at least two parameters (or operands) to be added together are detected. On the other hand, other types of utility extensions may not require any parameters in addition to the desired functionality For instance, an extension for displaying time-of-day may only require the functionality to be detected (e.g., keyword “time” is typed into search bar 202).

Referring again to operation S3950 of FIG. 3D, if it is decided that there was not enough information inputted into the search bar 202 for the extension to perform a functionality (“N” decision), the extension might not update its search menu item, but instead wait for the user to provide additional input (and thus processing would return to point “E” of FIG. 3A). On the other hand, if enough information was inputted into the search bar 202 (“Y” decision), the extension can perform the desired functionality on the designated parameter(s) (if any) and update the search menu item to show the results thereof, according to operation S3960. Thereafter, the updated search menu item is displayed in operation S3970.

FIGS. 4A and 4B illustrate a scenario involving the particular example of an extension that provides a simple calculator utility. FIG. 4A shows a state after the extension was triggered and the initial suggested search menu item of “= . . . ” is currently displayed. Particularly, the characters “23+” are currently inputted in the search bar 202 of FIG. 4A, but this does not provide enough parameters for the utility to perform the desired functionality (summation). Accordingly, the utility was unable to update its search menu item from the initial suggested item. However, FIG. 4B shows the state of the search menu after the user has inputted additional characters, such that the search bar input of “23+4*8” contains enough parameters for the utility to perform the desired calculation. Accordingly, in FIG. 4B, the search menu item has been updated to display the result of the calculation, i.e., “=55.”

Referring back to operation 53930 of FIG. 3D, however, the extension might not be a utility extension (“N” decision). Accordingly, processing proceeds to S3940, where the extension updates its search menu item according to the detected changes to the search bar input. Thereafter, the updated item is displayed in the search menu according to operation S3970. A specific example of this is shown in FIG. 5B, in which a site search extension produces an updated search menu item 501, which notifies the user that the item can be activated to perform a search on Amazon for items matching the query “kindl.”

When an extension updates the search menu item, in accordance with operation S3940 or S3950 of FIG. 3D, the URL associated with the item will typically change along with the displayed text. In the site search extension example of FIG. 5B, e.g., the URL associated with the updated search menu item 501 would be modified so that, if the user clicked or otherwise activated item 501, the browser 200 is redirected to Amazon's search results page for the query “kindl.” However, particularly in regard to utility extensions, it is not required for the extension to modify an associated URL when updating the search menu item. In fact, it is not strictly necessary for the search menu item to be associated with a URL.

It should be further noted that, regardless of the type of extension, it is not strictly necessary for the extension to update its search menu item in accordance with FIG. 3D every time an event listener detects that a character has been added or removed from the search bar input. For instance, the update may occur based other criteria. For example, an extension may be designed to periodically check the contents of the search bar 202 via the search bar API and update its search menu item if necessary. As another alternative, the extension may update its search menu time after a predetermined number of characters in the search bar input has changed. The extension may also be designed to update the search menu item per time intervals, e.g., a utility extension for displaying time-of-day might update its search menu item every second if it displays the time in hours:minutes:seconds.

Referring again to FIG. 3D, after the updated search menu item is displayed according to operation S3970, processing returns to point “E” in FIG. 3A.

Now, reference will be made back to FIG. 3A. As shown in this figure, the browser 200 may continue to monitor the status of the search bar 202 and search menu according to operations S370-S390, at least until the user indicates his/her intent to discontinue use of the search menu functionality (not shown in FIG. 3A). For instance, the user may indicate such intent by pressing the ‘Enter’ key thereby causing the browser's native code to search the inputted query. Otherwise, the user may discontinue use of the search menu functionality by pressing the ‘ESC’ key, clicking on a link in the browser's UI 201, etc.

As described in the foregoing embodiments, an extension utilizes an API in the browser 200 to enhance the browser's capabilities in regard to the search bar 202 and search menu. As such, the extension may be added to or removed from the browser 200 without the need to restart or reinstall the browser 200. This is particularly convenient, e.g., if the electronic device 100 is a mobile device like a tablet or smartphone.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

1. A method implemented in a processor-based device, comprising:
executing a user agent and an extension by the processor-based device, the extension communicating with the user agent via an application programming interface (API) provided in the user agent;
receiving, as input, characters typed by a user into a search bar of the user agent via a keyboard;
performing, by the extension, keyword or regular expression matching on the inputted characters via the API;
generating, by the extension, an item matching the inputted characters based on the keyword or regular expression matching; and
displaying the item in a drop-down search menu,
wherein the item is communicated from the extension to the user agent via the API.

2. The method of claim 1, wherein the item can be activated by the user to redirect the user agent to a corresponding resource via a network.

3. The method of claim 2, wherein the item is generated by the extension in such manner that said item includes at least one of an image and a syntax highlighting when displayed in the search menu.

4. The method of claim 1,
wherein the extension performs regular expression matching on the inputted characters to detect a functionality and a parameter,
wherein the item is generated as a result of the extension applying the functionality on the parameter.

5. The method of claim 1,
wherein the extension performs regular expression matching to detect a trigger in the inputted characters, and
wherein the extension generates the item in response to detecting the trigger, the item being displayed in the search menu along with at least one other item generated by the user agent.

6. The method of claim 1, further comprising:
receiving, by the user agent, a user command to employ a search mode while the item is displayed in the search menu,
wherein, when the search mode is employed as a result of the user command, the extension controls the contents of the search menu.

7. The method of claim 6, wherein the user command comprises the pressing of a key while the item is displayed in the search menu.

8. The method of claim 1, wherein the processor-based device is a mobile device.

9. The method of claim 1, wherein the extension is installed onto the processor-based device while the processor-based device is executing the user agent in such manner that, after installing the extension, the processor-based device does not need to restart or reinstall the user agent.

10. A device, comprising:
a keyboard;
a display screen; and
a computer processor which executes a user agent and an extension to perform a process including:
receiving, as input, characters typed by a user into a search bar of the user agent via the keyboard;
performing, by the extension, keyword or regular expression matching on the inputted characters via the API;
generating, by the extension, an item matching the inputted characters based on the keyword or regular expression matching; and
displaying the item on the display screen in a drop-down search menu,
wherein the item is communicated from the extension to the user agent via the API.

11. The device of claim 10, wherein the item can be activated by the user to redirect the user agent to a corresponding resource via a network.

12. The device of claim 11, wherein the item is generated by the extension in such manner that said item includes at least one of an image and a syntax highlighting when displayed in the search menu.

13. The device of claim 10,
wherein the extension performs regular expression matching on the inputted characters to detect a functionality and a parameter,
wherein the item is generated as a result of the extension applying the functionality on the parameter.

14. The device of claim 10,
wherein the extension performs regular expression matching to detect a trigger in the inputted characters, and
wherein the extension generates the item in response to detecting the trigger, the item being displayed in the search menu along with at least one other item generated by the user agent.

15. The device of claim 10, wherein the process further comprises:
receiving, by the user agent, a user command to employ a search mode while the item is displayed in the search menu,
wherein, when the search mode is employed as a result of the user command, the extension controls the contents of the search menu.

16. The device of claim 15, wherein the user command comprises the pressing of a key while the item is displayed in the search menu.

17. The device of claim 10, wherein the device is a mobile device.

18. The device of claim 10, wherein the extension is installed onto the device while the device is executing the user agent in such manner that, after installing the extension, the processor-based device does not need to restart or reinstall the user agent.

19. A non-transitory computer readable medium on which is stored code for a user agent which is executed by a processor-based device to perform a process comprising:
executing an extension by the processor-based device, the extension communicating with the user agent via an application programming interface (API) provided in the user agent;
receiving, as input, characters typed by a user into a search bar of the user agent via a keyboard;
performing, by the extension, keyword or regular expression matching on the inputted characters via the API;
generating, by the extension, an item matching the inputted characters based on the keyword or regular expression matching; and
displaying the item in a drop-down search menu,
wherein the item is communicated from the extension to the user agent via the API

20. The non-transitory computer readable medium of claim 19, wherein the item can be activated by the user to redirect the user agent to a corresponding resource via a network.

21. The non-transitory computer readable medium of claim 20, wherein the item is generated by the extension in such manner that said item includes at least one of an image and a syntax highlighting when displayed in the search menu.

22. The non-transitory computer readable medium of claim 19,
wherein the extension performs regular expression matching on the inputted characters to detect a functionality and a parameter,
wherein the item is generated as a result of the extension applying the functionality on the parameter.

23. The non-transitory computer readable medium of claim 19,
wherein the extension performs regular expression matching to detect a trigger in the inputted characters, and
wherein the extension generates the item in response to detecting the trigger, the item being displayed in the search menu along with at least one other item generated by the user agent.

24. The non-transitory computer readable medium of claim 19, the process further comprising:
receiving, by the user agent, a user command to employ a search mode while the item is displayed in the search menu,
wherein, when the search mode is employed as a result of the user command, the extension controls the contents of the search menu.

25. The non-transitory computer readable medium of claim 24, wherein the user command comprises the pressing of a key while the item is displayed in the search menu.

26. The non-transitory computer readable medium of claim 19, wherein the processor-based device is a mobile device.

27. The non-transitory computer readable medium of claim 19, wherein the extension is installed onto the processor-based device while the processor-based device is executing the user agent in such manner that, after installing the extension, the processor-based device does not need to restart or reinstall the user agent.
